(19) United States
(12) Patent Application Publication
(10) Pub. No.: US 2016/0042087 A1
(43) Pub. Date: Feb. 11, 2016

(54) Method, System And Front -End Device For Posting User Generated Content

(71) Applicant: TENCENT TECHNOLOGY (SHENZHEN) COMPANY LIMITED, Shenzhen City (CN)

(72) Inventor: Minwei YANG, Shenzhen (CN)

(21) Appl. No.: 14/886,136

(22) Filed: Oct. 19, 2015

Related U.S. Application Data
(63) Continuation of application No. PCT/CN2014/074875, filed on Apr. 8, 2014.

(30) Foreign Application Priority Data
Apr. 19, 2013 (CN) 201310137183.7

(51) Int. Cl. G06F 17/30; G06F 3/0484

(52) U.S. Cl. CPC G06F 17/30905; G06F 3/04842

(57) ABSTRACT

UGC material transmitted by a user is received and stored in a material database. An index of the UGC material and a corresponding sample of the UGC material are established and stored. The index of the UGC material is stored in an account of the user. After an instruction for posting UGC is received from a user, according to indexes of UGC materials in the account of the user, samples of the UGC materials are called and displayed. A sample of a UGC material selected by the user and UGC elements currently input by the user are received. Corresponding UGC material is read from the material database according to the sample of the UGC material, read UGC material, and UGC elements currently input by the user are combined into UGC, and the UGC is posted.

### CROSS-REFERENCE TO RELATED APPLICATIONS

This application is a continuation of International Application No. PCT/CN2014/074875, filed Apr. 8, 2014. This application claims the benefit and priority of Chinese Application No. 201310137183.7, filed Apr. 19, 2013. The entire disclosures of each of the above applications are incorporated herein by reference.

### FIELD

The present disclosure relates to computer and Internet data processing technologies and to posting user generated content (UGC).

### BACKGROUND

This section provides background information related to the present disclosure which is not necessarily prior art.

With the development of Internet technology, the network has become an important source from which people obtain information. Through the Internet web2.0, a user is both a visitor of website content and a creator of website content. Content generated by a user is called UGC. UGC includes content such as logs, photos, and the like, which are posted by users. In the Internet web2.0, because growth UGC is explosive, network information increases exponentially, and a more extensive, personalized situation is created, which plays a large role in the accumulation and dissemination of knowledge.

A website that posts UGC is generally called a UGC website system, or a system for posting UGC. For instance, the current commonly-used UGC website systems include micro-blog systems, social network service (SNS) systems, community forum systems, knowledge sharing systems, and so on. Some of the UGC website systems have integrated functions and many properties.

For example, a micro-blog, which is also called “Weibo”, is a UGC website system of information sharing, dissemination, and acquisition based on user relationships. The micro-blog belongs to a SNS system. A user may access the micro-blog through a wired communication network or wireless communication network, as well as access a variety of clients, post text and/or other multimedia information, including but not limited to a link, an image, an audio, a video, or some special applications (e.g., voting application), and achieve real-time sharing of the information.

Each component of a micro-blog is called micro-blog material. The types of micro-blog material include, but are not limited to, text, link, image, audio, video, or some special applications (e.g., voting application). Each component of a UGC is called UGC material, including but not limited to, text, link, image, audio, video, some special applications (e.g., voting application), or other types of information.

The manner for posting a micro-blog or other UGC is a single posting manner. That is to say, a single user submits all materials of the micro-blog or other UGC to a backend server all at once to complete the distribution.

The single posting manner for posting a micro-blog in existing technology has the following disadvantages. The single posting manner for distributing other UGC in other UGC website systems also has the same disadvantages.

The micro-blog materials cannot be separated in space. All materials (including text, image, sound, etc.) of a micro-blog message have to be converged to the same user terminal before the micro-blog message is posted. The process of converging each material to the same user terminal will involve many human-machine operations, such as material download, interface switching, application switching, etc. Therefore, when a user distributes a micro-blog including multiple materials, longer preparation time and more human-machine interactive operations are desired. Thus the level of timeliness is low, the operation efficiency is low, and the machine resources are wasted due to the fact that every human-machine interactive operation will occupy the corresponding machine resources.

The micro-blog materials cannot be separated in time. All materials of a micro-blog message have to be submitted all at once and cannot be submitted in batches, especially for a mobile terminal user. For example, when a discourse is desired to match a consistent picture or a picture with deep connotation, a user may consider the wording of the text and store part of the text in advance, which may need complex page switching, even application switching, and many human-machine interactive operations (such as click to view, etc.). Thus the operation time for distributing a competitive micro-blog including multiple materials by a user is long, the level of timeliness is low, the operation efficiency is low, and the machine resources are wasted due to the fact that every human-machine interactive operation will occupy the corresponding machine resources.

In short, when the existing UGC posting method posts UGC including multiple materials, the level of timeliness is low, the human-machine operation is complex, and the operation efficiency is low. Subsequently, the machine resources are wasted.

### SUMMARY

This section provides a general summary of the disclosure, and is not a comprehensive disclosure of its full scope or all of its features.

According to various embodiments of the present disclosure, a method, system, and front-end device for posting UGC is provided to improve the timeliness of posting UGC including multiple materials, decrease the complexity of human-machine interactive operation, increase the operation efficiency, and save the machine resources.

The method for posting UGC according to various embodiments of the present disclosure includes receiving a UGC material transmitted by a user and storing the UGC material, establishing an index of the UGC material and a sample of the UGC material, storing the sample of the UGC material corresponding to the index of the UGC material and storing the index of the UGC material stored in an account of the user and, after an instruction for posting UGC is received from a user, obtaining samples of UGC materials according to indexes of the UGC materials in the account of the user and displaying the samples of the UGC materials for the user to select, receiving a sample of UGC material selected by the user and UGC elements currently input by the user, reading a corresponding UGC material from the material database according to the sample of UGC material selected by the user, combining read UGC material and the UGC elements currently input by the user into UGC, and posting the UGC.

A system for posting UGC according to various embodiments of the present disclosure includes a receiving module configured to receive a UGC material transmitted by a user and store the UGC material into a material database, an index module configured to establish and store an index of the UGC material and a sample of the UGC material, wherein the index of the UGC material is stored in an account of the user, and a posting module, which includes a first posting unit configured to, after receiving an instruction for posting UGC from a user, obtain samples of UGC materials according to indexes of the UGC materials in the account of the user and display the samples for the user to select, a second posting unit configured to receive a sample selected by the user and UGC elements currently input by the user, and a third posting unit configured to read a corresponding UGC material from the material database according to the sample selected by the user, combine read UGC material and the UGC elements currently input by the user into UGC, and post the UGC.

A front-end device for posting UGC according to various embodiments of the present disclosure includes a terminal receiving module configured to receive a UGC material transmitted by a user and upload the UGC material to a system for posting UGC and a terminal posting module, which includes a first terminal posting unit configured to receive an instruction for posting UGC from a user and upload the instruction for posting UGC to the system for posting UGC, a second terminal posting unit configured to receive samples of UGC materials returned by the system for posting UGC and display the samples of UGC materials to the user, a third terminal posting unit configured to receive a selecting instruction of a sample of a UGC material from the user and a UGC element currently input by the user, upload the selecting instruction of the sample of the UGC material and a UGC element currently input by the user to the system for posting UGC, and a fourth terminal posting unit configured to receive UGC distributed by the system for posting UGC and display the UGC.

A method for posting UGC according to various embodiments of the present disclosure includes receiving a UGC material transmitted by a user and uploading the UGC material to a system for posting UGC, receiving an instruction for posting UGC from a user and uploading the instruction for posting UGC to the system for posting UGC, receiving samples of UGC materials returned by the system for posting UGC and displaying the samples of UGC materials to the user, receiving a selecting instruction of a sample of a UGC material from the user and a UGC element currently input by the user and uploading the selecting instruction of the sample of the UGC material and a UGC element currently input by the user to the system for posting UGC, and receiving UGC distributed by the system for posting UGC and displaying the UGC.

As can be seen, in the technical methods of the present disclosure, the UGC material transmitted by a user may be directly received and stored in a material database and an index of the UGC material and a sample of the UGC material may be established and stored, wherein the index of the UGC material is stored in an account of the user; therefore, the account of each user at least stores the index of the UGC material transmitted by the user, the UGC material may be received in different space and time and, thus, the inseparability of UGC material in space and time may be achieved. When a user desires to post UGC, samples of corresponding UGC materials may be obtained and displayed for the user to select according to indexes of the UGC materials in the account of the user. The user may select one or more samples among the samples of corresponding UGC materials and may simultaneously input other UGC elements. Subsequently, corresponding UGC material(s) may be read from the material database according to sample(s) selected by the user, read UGC material(s) and other elements currently input by the user may be combined into UGC, and the UGC may be posted. Therefore, through the technical methods of the present disclosure, the user may transmit a UGC material to the material database in different space (namely different scenarios) and different time. The account of a user stores indexes of UGC materials. When UGC including multiple materials is posted, corresponding UGC materials may be directly obtained from the material database according to selected indexes of UGC material and combined to post, thus, the inseparability of UGC materials in space and time may be overcome, and the preparation time for posting UGC including multiple materials and the human-machine interactive times may be decreased, the level of timeliness of posting UGC may be improved, the complexity of human-machine interactive operation may be decreased, the operation efficiency may be increased, and the machine resources may be saved. Furthermore, since the UGC materials are stored in the material database, when UGC is posted, a UGC material may be read from the material database instead of concentrating UGC materials to the user terminal, thus, the bandwidth resources occupied when the UGC materials are downloaded and uploaded may be saved.

Further areas of applicability will become apparent from the description provided herein. The description and examples in this summary are intended for purposes of illustration and are not intended to limit the scope of the present disclosure.

### DRAWINGS

The drawings described herein are for illustrative purposes only of selected embodiments and not all possible implementations, and are not intended to limit the scope of the present disclosure.

Features of the present disclosure are illustrated by way of examples and are not limited in the following figures, in which like numerals indicate like elements.

FIG. 1 is a flow diagram illustrating a method for posing UGC according to various embodiments of the present disclosure.

FIG. 2 is a flow diagram illustrating interactions when a user posts UGC according to various embodiments of the present disclosure.

FIG. 3a is a flow diagram illustrating a method for transmitting the UGC material via the third-party website according to various embodiments of the present disclosure.

FIG. 3b is a flow diagram illustrating a method for transmitting the UGC material via the local UGC website system according to various embodiments of the present disclosure.

FIG. 4 is a diagram illustrating the storage of materials and the indexes thereof according to various embodiments of the present disclosure.

FIG. 5a is a flow diagram illustrating interactions when new UGC material is added according to various embodiments of the present disclosure.

FIG. 5b is a flow diagram illustrating a sharing process according to various embodiments of the present disclosure.

FIG. 6 is a diagram illustrating a system for posing UGC according to various embodiments of the present disclosure.

FIG. 7 is a diagram illustrating a system for posing UGC according to various embodiments of the present disclosure.

FIG. 8 is a diagram illustrating a system for posing UGC according to various embodiments of the present disclosure.

FIG. 9 is a diagram illustrating a receiving module in the system for posing UGC according to various embodiments of the present disclosure.

FIG. 10 is a diagram illustrating a front-end device for posing UGC according to of the present disclosure.

FIG. 11 is a diagram illustrating a front-end device for posing UGC according to various embodiments of the present disclosure.

FIG. 12 is a diagram illustrating a method for posing UGC by a front-end device according to various embodiments of the present disclosure.

FIG. 13 is a diagram illustrating another structure of the system for posting UGC according to various embodiments of the present disclosure.

FIG. 14 is a diagram illustrating another structure of the front-end device according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

Reference will now be made in detail to examples, which are illustrated in the accompanying drawings. In the following detailed description, numerous details are set forth in order to provide a thorough understanding of the present disclosure. The figures are illustrations of various embodiments, in which modules or procedures shown in the figures are not necessarily required for implementing the present disclosure. In other instances, well-known methods, procedures, components, and circuits have not been described in detail so as not to unnecessarily obscure aspects of the examples. As used herein, the term “includes” means includes but not limited to, the term “including” means including but not limited to. The term “based on” means based at least in part on. In addition, the terms “a” and “an” are intended to denote at least one of a particular element.

The UGC described in the present disclosure may be a micro-blog or other information content created by a user. The system for posting UGC, namely UGC website system, may be a micro-blog system or other system for posting UGC, such as a SNS system, a community forum system, or a knowledge sharing system.

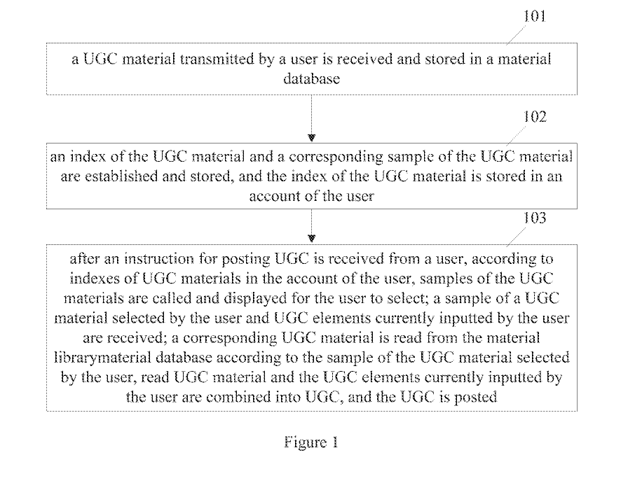

FIG. 1 is a flow diagram illustrating a method for posing UGC according to various embodiments of the present disclosure. As shown in FIG. 1, the method may include the following operations.

Block 101: A UGC material transmitted by a user is received and the UGC material is stored in a material database. According to various embodiments, a material database is established in a system for posting UGC to store various materials, generate an index for each material, and provide a management unit for each material. The material database is a public component and UGC materials transmitted by all users are stored in the material database.

Block 102: An index of the UGC material and a corresponding sample of the UGC material are established, the sample of the UGC material is stored corresponding to the index of the UGC material, and the index of the UGC material is stored in an account of the user. According to various embodiments, there is a material-index list of the user in the account of the user. Each record in the material-index list is an index value of an UGC material. The sample of the UGC material and the index of the UGC material may also be stored in the material database and there is a relationship which associates the sample of the UGC material and the index of the UGC material. According to the index value, corresponding material sample and corresponding UGC material may be read from the material database. In the example, material indexes of each user are stored in the account of the user and data of material indexes in the account of each user is private data of the user and can only be used by the user.

Block 103: after an instruction for posting UGC is received from a user, according to indexes of UGC materials in the account of the user, samples of the UGC materials are called and displayed for the user to select. A sample of a UGC material selected by the user and UGC elements currently input by the user are received. A corresponding UGC material is read from the material database according to the sample of the UGC material selected by the user, read UGC material and the UGC elements currently input by the user are combined into UGC, and the UGC is posted.

The instruction for posting UGC may be triggered by the user when the user clicks a corresponding button and the instruction for posting UGC may be detected by a system for posting UGC, or by a terminal, such as a front-end device.

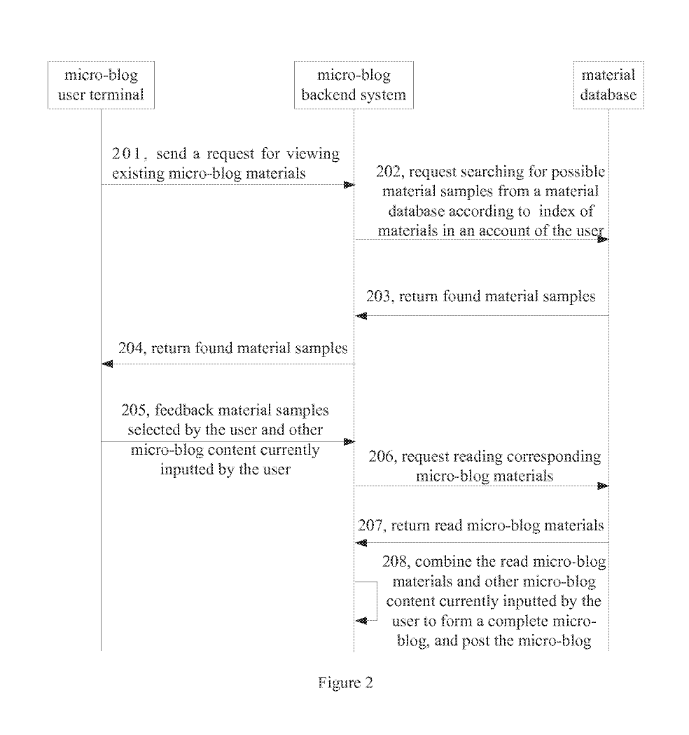

FIG. 2 is a flow diagram illustrating interactions when a user posts UGC according to various embodiments of the present disclosure. In the example, the micro-blog is taken as the UGC. As shown in FIG. 2, the interactions may include the following.

Block 201: A user sends an instruction for posting a micro-blog, after receiving the instruction for posting a micro-blog from the user. A micro-blog user terminal (such as a micro-blog client or a micro-blog browser) may send a request for viewing existing micro-blog materials to a micro-blog backend system.

Block 202: The micro-blog backend system may search a material-index list stored in an account of the user, read an index value of each material (if the size of page is limited, the read index values of materials may be paged according to designated size of page), and request searching for possible material samples from a material database according to the read index values. For example, the micro-blog backend system may send a request carrying the read index values to the material database to search for possible material samples, so that possible material samples may be searched out from the material database according to the read index values.

Block 203: The material database may return found material samples to the micro-blog backend system.

Block 204: The micro-blog backend system may return the found material samples to the micro-blog user terminal.

Block 205: The micro-blog user terminal displays the material samples for the user to select. The user may select from the material samples (for example, check and confirm suitable material samples), input other the micro-blog content (such as other comments, namely UGC elements currently input by the user), and click to post. The micro-blog user terminal may receive the material samples selected by the user and other micro-blog content currently input by the user, and return the data to the micro-blog backend system.

Block 206: The micro-blog backend system may request reading corresponding micro-blog materials from the material database according to indexes corresponding to the material samples selected by the user. For example, the micro-blog backend system may send a request carrying the indexes corresponding to the material samples selected by the user for reading corresponding micro-blog materials, so that corresponding micro-blog materials may be read from the material database according to the indexes corresponding to the material samples selected by the user.

The validity of the request for obtaining micro-blog material sent by the user may be verified. Because some users may know how to use tools to rewrite the material index field in a message sent to a server, so as to explore materials which do not belong to their own accounts, each time obtaining a material index value provided by a user, the server will verify whether the corresponding material requested by the user really belongs to an account of the user. The verification method, for example, may include the following. The verification is performed according to an identity or key of the current user and user information in the material index list stored in the material database. The user information includes the owner and the sharers of the material. When the current user is the owner or a sharer of the material, the request for obtaining micro-blog material is valid; otherwise, the request for obtaining micro-blog material is invalid.

Block 207: The material database may return read micro-blog materials to the micro-blog backend system.

Block 208: The micro-blog backend system may combine the read micro-blog materials and other micro-blog content currently input by the user to form a complete micro-blog, and transmits the micro-blog to a micro-blog posting interface, so that subsequent processing may be performed and the micro-blog may be posted.

Through the above operations, the micro-blog including multiple materials is posted successfully. When the UGC material transmitted by a user is received in block 101, there may be at least two implementation modes for transmitting the UGC material. For example, the UGC material may be transmitted via a third-party website or the local UGC website system.

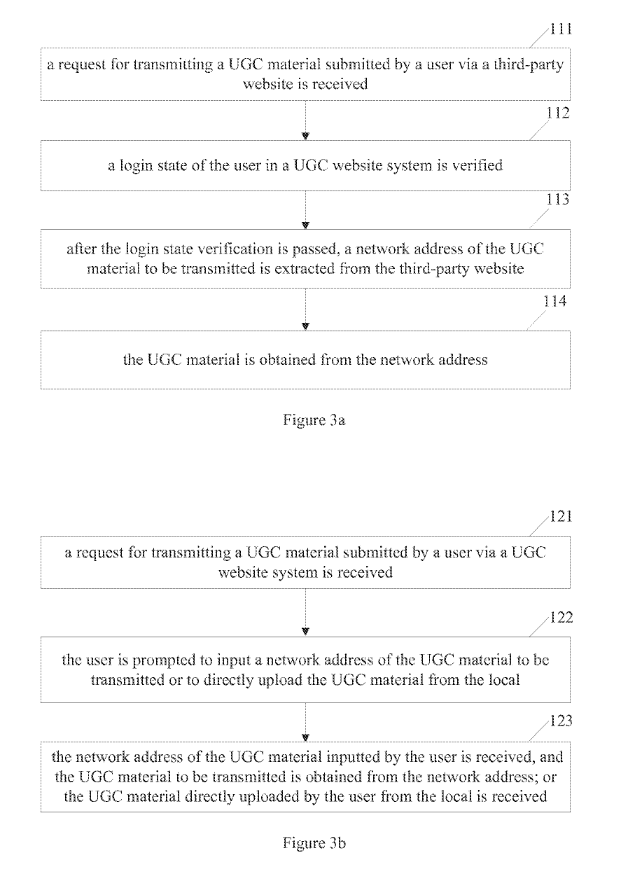

FIG. 3a is a flow diagram illustrating a method for transmitting the UGC material via the third-party website according to various embodiments of the present disclosure. As shown in FIG. 3a, the method for transmitting the UGC material via the third-party website may include the following operations.

Block 111: A request for transmitting a UGC material submitted by a user via a third-party website is received.

Block 112: A login state of the user in a UGC website system is verified.

Block 113: After the login state verification is passed, a network address of the UGC material to be transmitted is extracted from the third-party website.

Block 114: The UGC material is obtained from the network address.

The UGC website system refers to the destination UGC website system to which the user wants to send the UGC material.

The above-mentioned approach may greatly facilitate the post of UGC in some scenes that materials are dispersed. For example, a user may find a beautiful landscape picture on a third-party website and want to take the landscape picture as a UGC material to post UGC. Therefore, according to various embodiments, a dedicated application programming interface (API) may be provided on the third-party website and the API may set a send button next to the landscape picture. When the user clicks the send button, it is determined that the user wants to take the landscape picture as a UGC material and send the UGC material and a transmission request is generated. The transmission request may be sent to the UGC network system and the UGC network system may verify a login state of the user in the UGC website system. If the user is not currently logged in the UGC website system, the UGC website system may return the user a page for verifying the login state of the user. The user may input verification information, such as user name and password, in the page to be verified. After the verification is passed, the API may extract a network address of the landscape picture to be transmitted from the third-party website and send the network address to the UGC website system. The UGC website system may obtain the landscape picture from the network address, take the landscape picture as a UGC material, and store the UGC material in a material database of the UGC website system. Thus the transmission of the UGC material is completed. Subsequently, the user may select the landscape picture from the material database of the UGC website system and post a piece of UGC by taking the landscape picture as a UGC material.

In conventional technology, when UGC is posted based on the landscape picture on the third-party website, it is necessary to download the landscape picture to the local user terminal first and then upload the landscape picture to the UGC website system to post a piece of UGC. In general, the resolution of the landscape picture is very high and the file size of the landscape picture is very large. Thus, a large amount of up and down bandwidth resources is occupied, the speed of posting UGC is slow, and the responsiveness is low. In contrast, according to various embodiments of the present disclosure, the network address of the landscape picture is directly sent to the UGC website system and the UGC website system directly obtains the landscape picture from the network address. It is not necessary to download the landscape picture to the user terminal and upload the landscape picture from the user terminal when UGC is posted. Thus, a large amount of uplink and downlink bandwidth resources is saved, the speed of posting UGC is increased, the level of timeliness is enhanced, and the user is facilitated to share resources with buddies through UGC in the scenes where the material resources are dispersed.

FIG. 3b is a flow diagram illustrating a method for transmitting the UGC material via the local UGC website system according to various embodiments of the present disclosure. As shown in FIG. 3b, the method for transmitting the UGC material via the local UGC website system may include the following operations.

Block 121: A request for transmitting a UGC material submitted by a user via a UGC website system is received. For instance, the UGC website system may provide a material management page to the user and the user may click a “add material” button on the page to send the request for transmitting the UGC material.

Block 122: The user is prompted to input a network address of the UGC material to be transmitted or to directly upload the UGC material from the local. The user may input the network address of the UGC material to be transmitted or directly upload the UGC material from the local.

Block 123: The network address of the UGC material input by the user is received and the UGC material to be transmitted is obtained from the network address, or the UGC material directly uploaded by the user from the local is received.

Subsequently, when UGC including the UGC material is posted, the UGC material may be directly read from the material database by the UGC website system, rather than have to be concentrated on the user terminal to be uploaded and posted. Thus, the network bandwidth usage of uploading operation may be saved.

After the UGC material transmitted by the user is received, the UGC material may be stored in the material database. There may be multiple storage manners. For instance, a file system provided by the operating system may be used to store the UGC material or the compact storage of large files may be adopted.

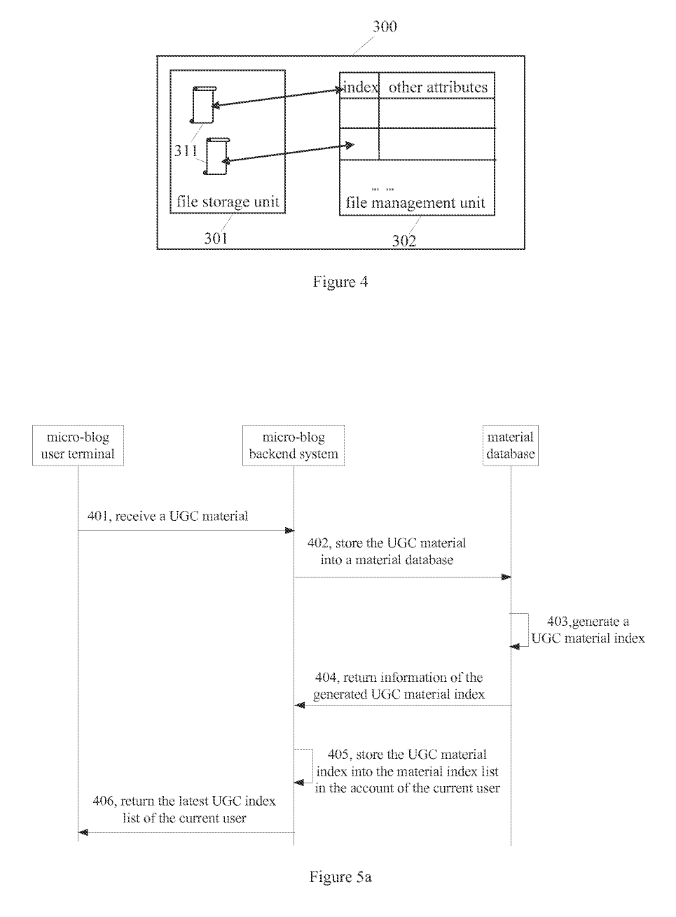

FIG. 4 is a diagram illustrating the storage of materials and the indexes thereof according to various embodiments of the present disclosure. As shown in FIG. 4, the UGC materials 311 are stored in a file storage unit 301 of the material database 300, an index of a UGC material is generated based on the storage location information of the UGC material (there is a one to one function mapping relationship between an index and a storage location), and the indexes of the UGC materials are stored in a file management unit 302. The index of each UGC material may include other attributes, for instance, the size of the UGC material, the storage time, a flag (indicating whether the UGC material has ever been used, whether the UGC material is possessed by multiple persons, whether the UGC material is deleted, and so on), a user information list, and so on. The user information list may include an owner information list and a sharer information list. The owner refers to the initial sender of the UGC material who possesses the rights for using (such as posting), sharing, and deleting the UGC material. The sharer refers to the sharing object with which the owner shares the UGC material, and the sharer generally only possesses the permissions for using the UGC material.

The method for storing the index of the UGC material in an account of the user in block 102 may include the following. A material index list may be added in an account of each user in the UGC website system. The main fields of the material index list include a material index, the time for obtaining the index, a material source, a material type (text, link, image, audio, video, etc.), a flag indicating whether the UGC material has been used, a flag indicating whether the UGC material is possessed (or shared) by multiple persons, and permission information owned by the user for the UGC material (such as owner permission or sharer permission, namely the user is the owner or the sharer of the UGC material). The permission information may be determined according to an ID of the user, the owner information, and the sharer information in the user information list in the material database.

According to various embodiments, the permission information may be directly stored in the material index list in the account of the user. When it is verified that whether the user is the owner or a sharer of the UGC material, the verification may be performed according to the permission information in the material index list in the account of the user. According to various embodiments, the permission information in the material index list in the account of the user may be taken as an identifier to be returned to the user and the real permission control is processed by the file management unit 302 of the material database. That is to say, the UGC website system may send a verification request including a UGC material index and a user ID or key to the file management unit 302 of the material database and the file management unit 302 may search the user information list in the index of the UGC material according to the user ID or key, so as to verify whether the user is the owner or a sharer of the UGC material.

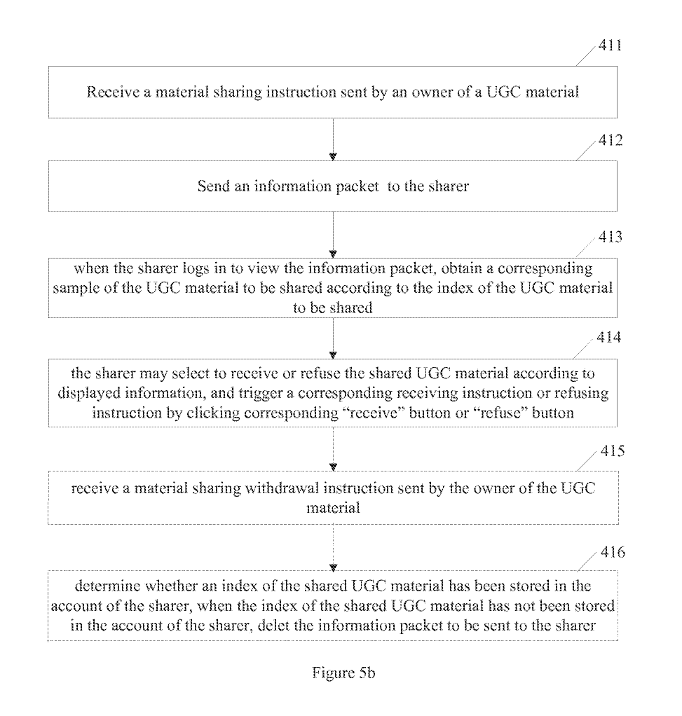

FIG. 5a is a flow diagram illustrating interactions when new UGC material is added according to various embodiments of the present disclosure. As shown in FIG. 5a, the micro-blog system is taken as an example. The interactions may include the following.

Block 401: A micro-blog backend system receives a UGC material transmitted by a user via a micro-blog user terminal.

Block 402: The micro-blog backend system stores the UGC material in a material database.

Block 403: The material database side generates a UGC material index according to the storage location of the UGC material in the material database and adds an index record for the UGC material index in a file management unit of the material database. The size of the UGC material, the storage time of the UGC material, and the lag (indicating whether the UGC material has ever been used, whether the UGC material is possessed by multiple persons, whether the UGC material is deleted, and so on) in the index record may be determined by the attributes of the UGC material. At this time, the user information list may record the owner information (namely information of the user transmitting the UGC material). The material database side may further generate a thumbnail sample for the UGC material, and store the thumbnail sample in a corresponding relationship with the UGC material.

Block 404: The material database side returns information of the generated UGC material index to the micro-blog backend system.

Block 405: The micro-blog backend system stores the information of the UGC material index into the material index list in the account of the current user.

Block 406: The micro-blog backend system may further return the latest UGC index list of the current user to the micro-blog user terminal.

The above-mentioned process in FIG. 5a is a conventional process for adding a UGC material by actively transmitting a UGC material by a user. The transmitter of the UGC material (namely the user transmitting the UGC material) is generally recorded as the owner of the UGC material. According to various embodiments, the method may further include the following. The owner of the UGC material may share the UGC material with other users (namely the sharers), so that a UGC material index may be newly added in an account of each sharer. The owner and all sharers of the UGC material may post UGC using the UGC material. FIG. 5b is a flow diagram illustrating a sharing process according to various embodiments of the present disclosure. FIG. 5b is a flow diagram of the sharing process.

Block 411: a material sharing instruction sent by an owner of a UGC material may be received. The material sharing instruction includes an index of the UGC material to be shared and information of a sharer. The index of the UGC material to be shared is selected by the owner from indexes of UGC materials in an account of the owner. According to various embodiments, for instance, in a micro-blog system, when permission information in an account of the user indicates that the user is an owner, samples corresponding to indexes of micro-blog materials of the user may be displayed on a page of a micro-blog user terminal. The user may select a sample of a micro-blog material to be shared from the samples, click the “share” button after the selection, and then input information of a sharer (namely share object). Finally, the user may click “OK” to send a sharing instruction of selected micro-blog material.

Block 412: An information packet may be sent to the sharer. The information packet may include an index of the UGC material to be shared, information of the owner of the UGC material, and information of a receiving instruction and a refusing instruction. There may be a variety of methods for sending the information packet. For example, the methods for sending the information packet may include, but are not limited to, the following. In occasions that only internal resources of the UGC website system are applied, the information packet may be sent using a system message, small tips within a page, a small popups outside the page, or the like. In occasions that external resources of the UGC website system are integrated, the information packet may be sent using an email, a micro-letter, a mobile phone short message, or third-party cooperation communication means.

Block 413: When the sharer logs in to view the information packet, a corresponding sample of the UGC material to be shared may be called according to the index of the UGC material to be shared. For example, the corresponding sample of the UGC material to be shared may be called from the material database. The called sample of the UGC material and information of the owner of the UGC material may be displayed to the sharer.

Block 414: The sharer may select to receive or refuse the shared UGC material according to displayed information. For example, the sharer may trigger a corresponding receiving instruction or refusing instruction by clicking a corresponding “receive” button or “refuse” button. After the sharer triggers information of the receiving instruction in the information packet, the index of the UGC material to be shared in the information packet may be stored in an account of the sharer and permission information of the index of the UGC material in the account of the sharer may be that the user possesses sharer permission about the UGC material. The sharer permission may be set according to actual operational requirements. For instance, the sharer may use the UGC material and delete the index of the UGC material from the account of the sharer. However, the sharer cannot delete the UGC material and the index thereof from the material database.

With above mentioned process for sharing a UGC material, some UGC materials, such as a beautiful landscape material, may be shared to sharers, and only the information packet with little information is transmitted between the sharer and the owner. That is to say, shared information is the index of the UGC material other than the UGC material file. Thus, the bandwidth resource is saved and sharing speed is very fast. When the sharer posts UGC using the landscape material, the backend system may directly call the landscape material file from the material database without downloading and uploading the material file. Thus the posting speed for posting UGC by a sharer may be increased and bandwidth resource may be saved when UGC is posted.

According to various embodiments of the present disclosure, when the owner of the UGC material wants to withdraw the shared UGC material, the process may further include the following operations in blocks 415 and 416.

Block 415: After the material sharing instruction sent by the owner of the UGC material is received, a material sharing withdrawal instruction sent by the owner of the UGC material may be further received. The material sharing withdrawal instruction includes an index of a shared UGC material to be withdrawn.

Block 416: It is determined whether an index of the shared UGC material has been stored in the account of the sharer. When the index of the shared UGC material has not been stored in the account of the sharer, the information packet to be sent to the sharer is deleted. That is to say, after the sharer loges in, the information packet will not be displayed to the sharer.

In the present disclosure, multiple extension operations may be performed on the UGC material. For instance, the method may further include the following. A deleting instruction sent by a user for deleting a UGC material stored in the account of the user may be received. The deleting instruction includes an identifier of an index of UGC material to be deleted. The index of the UGC material designated by the identifier of the index of the UGC material may be deleted from the account of the user.

According to various embodiments, the processing of deleting instruction sent by the owner of the UGC material may differ from the processing of the deleting instruction sent by a sharer of the UGC material. In the example, information of the owner and sharers of the UGC material may be recorded. For instance, both of above-mentioned user list information in the index record of the UGC material in the material database and permission information in the index record of the UGC material in the account of the user record information of the owner and/or sharers of the UGC material. According to various embodiments of the present disclosure, after the deleting instruction sent by a user for deleting a UGC material stored in the account of the user is received, it may be further verified whether the user is the owner of the UGC material to be deleted. When the user is the owner of the UGC material to be deleted, information of sharers of the UGC material may be further searched for. When information of sharers of the UGC material may be found from the material database according to an index of the UGC material, the index of the UGC material designated by the identifier of the index of UGC material in the deleting instruction may be deleted from the accounts of the sharers.

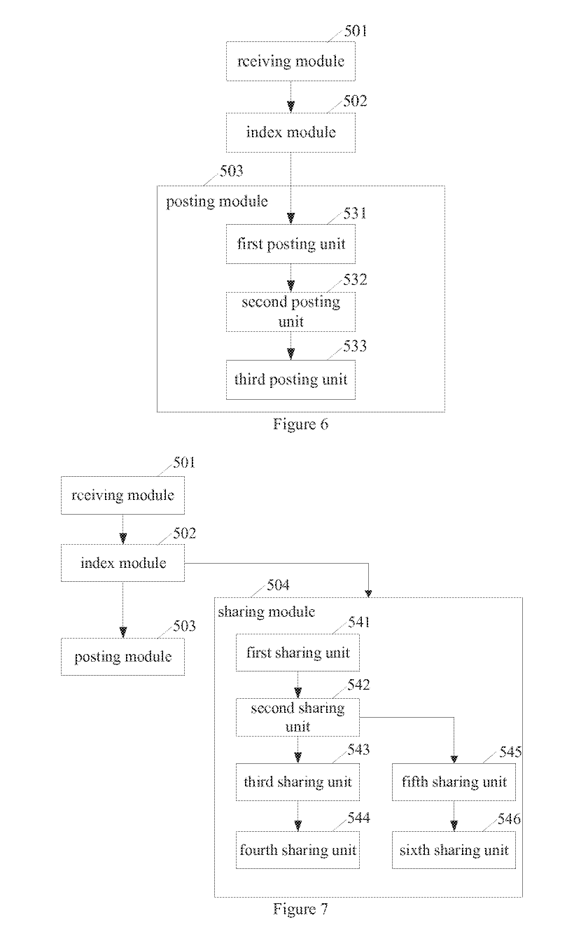

Corresponding with above-mentioned methods, the present disclosure also provides a system for posting UGC, which is configured to execute the above-mentioned methods. FIG. 6 is a diagram illustrating a system for posing UGC according to various embodiments of the present disclosure. As shown in FIG. 6, the system may include a receiving module 501, an index module 502, and a posting module 503. The posting module 503 may include a first posting unit 531, a second posting unit 532, and a third posting unit 533.

The receiving module 501 is configured to receive a UGC material transmitted by a user and store the UGC material into a material database.

The index module 502 is configured to establish an index of the UGC material and a corresponding sample of the UGC material, store the sample of the UGC material and the index of the UGC material as an association, and store the index of the UGC material in an account of the user.

The first posting unit 531 is configured to, after receiving an instruction for posting UGC from a user, according to indexes of UGC materials in the account of the user, call samples of the UGC materials, and display the samples for the user to select.

The second posting unit 532 is configured to receive samples of UGC materials selected by the user and UGC elements currently input by the user.

The third posting unit 533 is configured to read corresponding UGC materials from the material database according to the samples of the UGC materials selected by the user, combine read UGC materials and the UGC elements currently inputted by the user into UGC, and post the UGC.

FIG. 7 is a diagram illustrating a system for posing UGC according to various embodiments of the present disclosure. As shown in FIG. 7, the system may further include a sharing module 504 in addition to the modules shown in FIG. 6. The sharing module 504 may include a first sharing unit 541, a second sharing unit 542, a third sharing unit 543, and a fourth sharing unit 544.

The first sharing unit 541 is configured to receive a material sharing instruction sent by an owner of a UGC material. The material sharing instruction includes an index of the UGC material to be shared and information of a sharer. The index of the UGC material to be shared is selected by the owner from indexes of UGC materials in an account of the owner.

The second sharing unit 542 is configured to send an information packet to the sharer. The information packet may include an index of the UGC material to be shared, information of the owner of the UGC material, and information of a receiving instruction or a refusing instruction.

The third sharing unit 543 is configured to, when the sharer logs in to view the information packet, call a corresponding sample of the UGC material to be shared according to the index of the UGC material to be shared, and display the called sample of the UGC material and information of the owner of the UGC material to the sharer.

The fourth sharing unit 544 is configured to, after the sharer triggers the information of a receiving instruction in the information packet, store the index of the UGC material to be shared in the information packet in an account of the sharer.

In various embodiments, the sharing module 504 may further include a fifth sharing unit 545 and a sixth sharing unit 546. The fifth sharing unit 545 is configured to receive a material sharing withdrawal instruction sent by the owner of the UGC material. The material sharing withdrawal instruction includes an index of the shared UGC material which is to be withdrawn.

The sixth sharing unit 546 is configured to determine whether the index of the shared UGC material has been stored in the account of the sharer, when the index of the shared UGC material has not been stored in the account of the sharer, delete the information packet to be sent to the sharer.

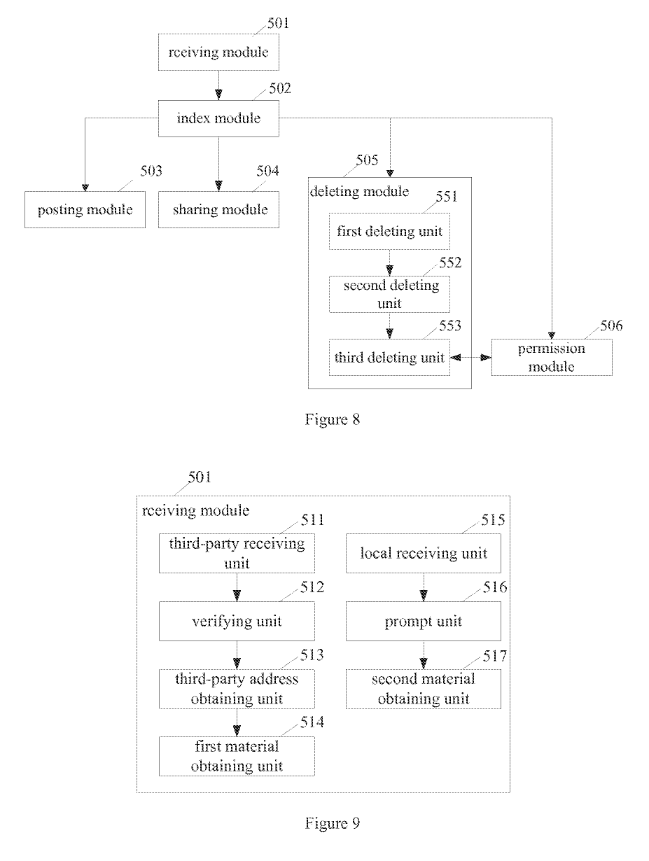

FIG. 8 is a diagram illustrating a system for posing UGC according to yet another embodiment. As shown in FIG. 8, the system may further include a deleting module 505 besides the modules shown in FIG. 7. The deleting module 505 may include a first deleting unit 551 and a second deleting unit 552.

The first deleting unit 551 is configured to receive a deleting instruction, sent by a user, for deleting a UGC material stored in the account of the user. The deleting instruction includes an identifier of an index of the UGC material to be deleted.

The second deleting unit 552 is configured to, after the first deleting unit 551 receives the deleting instruction, delete the index of the UGC material designated by the identifier of the index of the UGC material from the account of the user.

In various embodiments, the system may further include a permission module 506, configured to record information of the owner and sharers of the UGC material. The deleting module 505 may further include a third deleting unit 553, configured to, after the first deleting unit 551 receives the deleting instruction sent by a user for deleting a UGC material stored in the account of the user, verify whether the user is the owner of the UGC material to be deleted, when the user is the owner of the UGC material to be deleted, search for information of sharers of the UGC material, and delete the index of the UGC material designated by the identifier of the index of UGC material in the deleting instruction from the accounts of the sharers.

When above mentioned receiving module 501 receives the UGC material transmitted by the user, there may be at least two implementation modes of transmitting the UGC material. For example, the UGC material may be transmitted via a third-party website or the local UGC website system.

FIG. 9 is a diagram illustrating a receiving module in the system for posing UGC according to various embodiments of the present disclosure. As shown in FIG. 9, in order to transmit the UGC material via the third-party website, the receiving module 501 may include a third-party receiving unit 511, a verifying unit 512, a third-party address obtaining unit 513, and a first material obtaining unit 514. The third-party receiving unit 511, the verifying unit 512, and the third-party address obtaining unit 513 may be configured in the third-party website in an API format.

The third-party receiving unit 511 is configured to receive a request for transmitting a UGC material submitted by a user via a third-party website. The verifying unit 512 is configured to interact with a UGC website system and verify a login state of the user in the UGC website system. The UGC website system refers to the destination UGC website system to which the user wants to send the UGC material. The third-party address obtaining unit 513 is configured to, after the login state verification is passed, extract a network address of the UGC material from the third-party website and send the network address to the first material obtaining unit 514. The first material obtaining unit 514 is set in the UGC website system and is configured to obtain the UGC material from the network address.

In order to transmit the UGC material via the local UGC website system, the receiving module 501 may include a local receiving unit 515, a prompt unit 516, and a second material obtaining unit 517. The local receiving unit 515 is configured to receive a request for transmitting a UGC material submitted by a user via a UGC website system. The prompt unit 516 is configured to prompt the user to input a network address of the UGC material to be transmitted or prompt the user to directly upload the UGC material from the local. The second material obtaining unit 517 is configured to receive the network address of the UGC material input by the user and obtain the UGC material to be transmitted from the network address or receive the UGC material directly uploaded by the user from the local.

There may be multiple physical locations of the modules in above system for posting UGC. For instance, if the whole UGC website system is divided into a front-end system and a backend system, the modules configured to interact with a user in above system may be placed in the front-end system. The architecture form of the front-end system and the backend system generally includes, but is not limited to, browser/server (B/S) mode and client/server (C/S) mode. In the B/S mode, the front-end system and the backend system may be configured in the network side, and a browser may be installed on the user terminal. The user may access the front-end system via the browser to interact with the backend system, so that corresponding functions may be completed. In the C/S mode, the front-end system may be set in a client on the user terminal. The client is software installed on the user terminal. The user may interact with the backend system through the client to complete corresponding functions.

The above system for posting UGC may be taken as a backend system, and a front-end device for posting UGC may be set on the front end. The front-end device is mainly configured to interact with a user as an interactive interface between the user and the system for posting UGC to complete the transmitting and displaying of corresponding information. The front-end device may be set in the network side and accessed by a browser or may be directly installed on the user terminal in the form of a client.

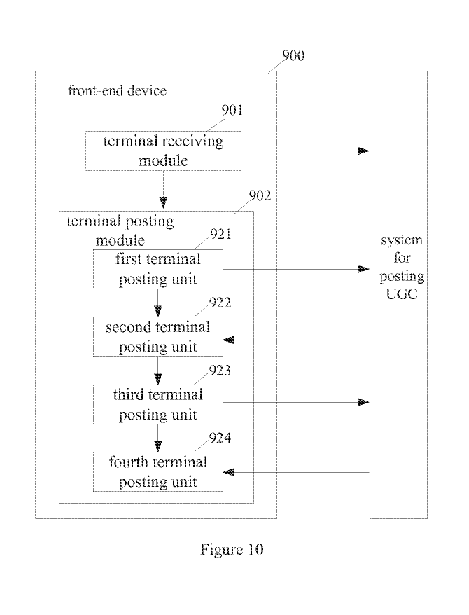

FIG. 10 is a diagram illustrating a front-end device for posing UGC according to various embodiments of the present disclosure. As shown in FIG. 10, the front-end device 900 may include a terminal receiving module 901 configured to receive a UGC material sent by a user and upload the UGC material to above mentioned system for posting UGC, namely the backend system. The receiving module 501 in the system for posting UGC receives the UGC material and stores the UGC material in a material database and the index module 502 in the system for posting UGC establishes and stores an index of the UGC material and a corresponding sample of the UGC material and stores the index of the UGC material in an account of the user.

The front-end device 900 may further include a terminal posting module 902. The terminal posting module 902 may include a first terminal posting unit 921, a second terminal posting unit 922, a third terminal posting unit 923, and a fourth terminal posting unit 924.

The first terminal posting unit 921 is configured to receive an instruction for posting UGC from a user and upload the instruction for posting UGC to above mentioned system for posting UGC. Subsequently, the first posting unit 531 in the system for posting UGC may, according to indexes of UGC materials in the account of the user, call samples of the UGC materials and return the samples of the UGC materials back to the front-end device. The second terminal posting unit 922 is configured to receive samples of UGC materials returned by the system for posting UGC and display the samples to the user.

The third terminal posting unit 923 is configured to receive a selecting instruction of a sample of a UGC material from the user and a UGC element currently input by the user and upload the selecting instruction of the sample of the UGC material and a UGC element currently input by the user to the system for posting UGC. The third terminal posting unit 923 may upload the selecting instruction of the sample of the UGC material and a UGC element currently input by the user to the second posting unit 532 in the system for posting UGC. The second posting unit 532 may read a corresponding UGC material from the material database according to the sample of the UGC material selected by the user and combine read UGC materials and the UGC elements currently input by the user into UGC and distribute the UGC to the front-end device. The fourth terminal posting unit 924 is configured to receive the UGC distributed by the system for posting UGC and display the UGC.

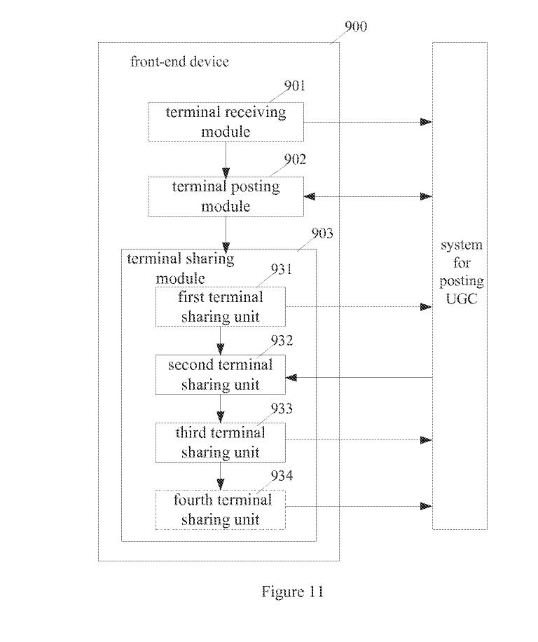

FIG. 11 is a diagram illustrating a front-end device for posing UGC according to various embodiments of the present disclosure. As shown in FIG. 11, the front-end device further includes a terminal sharing module 903. The terminal sharing module 903 may include a first terminal sharing unit 931, a second terminal sharing unit 932, and a third terminal sharing unit 933.

The first terminal sharing unit 931 is configured to receive a material sharing instruction sent by an owner of a UGC material and upload the material sharing instruction to the system for posting UGC. The first sharing unit 541 of the system for posting UGC may receive the material sharing instruction. The material sharing instruction includes an index of the UGC material to be shared and information of a sharer. The index of the UGC material to be shared is selected by the owner from indexes of UGC materials in an account of the owner. Subsequently, the second sharing unit 542 of the system for posting UGC may send an information packet to the sharer. The information packet may include an index of the UGC material to be shared, information of the owner of the UGC material, and information of a receiving instruction and a refusing instruction. The third sharing unit 543 of the system for posting UGC may, when the sharer logs in to view the information packet, call a corresponding sample of the UGC material to be shared according to the index of the UGC material to be shared and return the called sample of the UGC material back to the front-end device.

The second terminal sharing unit 932 is configured to, when the sharer logs in to view the information packet including the index of the UGC material to be shared, information of the owner of the UGC material and information of a receiving instruction and a refusing instruction, receive information of the information packet and the sample of the UGC material returned by the system for posting UGC, and display the sample of the UGC material and information of the information packet to the sharer.

The third terminal sharing unit 933 is configured to receive instruction information for receiving or refusing the information packet triggered by the sharer and upload the instruction information to the system for posting UGC. Subsequently, the fourth sharing unit 544 of the system for posting UGC may store the index of the UGC material to be shared in the information packet in an account of the sharer.

According to various embodiments, the terminal sharing module 903 may further include a fourth terminal sharing unit 934, which is configured to receive a material sharing withdrawal instruction sent by the owner of the UGC material, and upload the material sharing withdrawal instruction to the system for posting UGC. The material sharing withdrawal instruction includes an index of a shared UGC material which is withdrawn. The fifth sharing unit 545 of the system for posting UGC may receive the material sharing withdrawal instruction and the sixth sharing unit 546 of the system for posting UGC may determine whether the index of the shared UGC material has been stored in the account of the sharer, and when the index of the shared UGC material has not been stored in the account of the sharer, delete the information packet to be sent to the sharer.

According to various embodiments, the front-end device may further include a terminal deleting module, which is configured to receive a deleting instruction for deleting a UGC material sent by the owner of the UGC material, and upload the deleting instruction to the system for posting UGC. The deleting instruction includes an identifier of an index of the UGC material to be deleted. The first deleting unit 551 of the system for posting UGC may receive the deleting instruction and the second deleting unit 552 of the system for posting UGC may delete the index of the UGC material designated by the identifier of the index of the UGC material from the account of the user.

According to various embodiments, the terminal receiving module 901 may include a third-party receiving unit, a verifying unit, and a third-party address obtaining unit. The third-party receiving unit, the verifying unit, and the third-party address obtaining unit may be set in the third-party website. The third-party receiving unit is configured to receive a request for transmitting a UGC material submitted by a user via a third-party website. The verifying unit is configured to interact with a UGC website system and verify a login state of the user in the UGC website system. The UGC website system refers to the destination UGC website system to which the user wants to send the UGC material.

The third-party address obtaining unit is configured to, after the login state verification is passed, extract a network address of the UGC material to be transmitted from the third-party website, and upload the network address to the system for posting UGC. The first material obtaining unit 514 of the system for posting UGC may obtain the UGC material from the network address.

According to various embodiments of the present disclosure, the terminal receiving module may further include a local receiving unit, a prompt unit, and a transmitting unit.

The local receiving unit is configured to receive a request for transmitting a UGC material submitted by a user via a UGC website system. The prompt unit is configured to prompt the user to input a network address of the UGC material to be transmitted or prompt the user to directly upload the UGC material from the local. The transmitting unit is configured to upload the network address of the UGC material input by the user to the system for posting UGC or upload the UGC material directly uploaded by the user from the local to the system for posting UGC. The second material obtaining unit 517 of the system for posting UGC may receive the uploaded network address of the UGC material to be transmitted and obtain the UGC material to be transmitted from the network address or receive the uploaded UGC material directly uploaded by the user from the local.

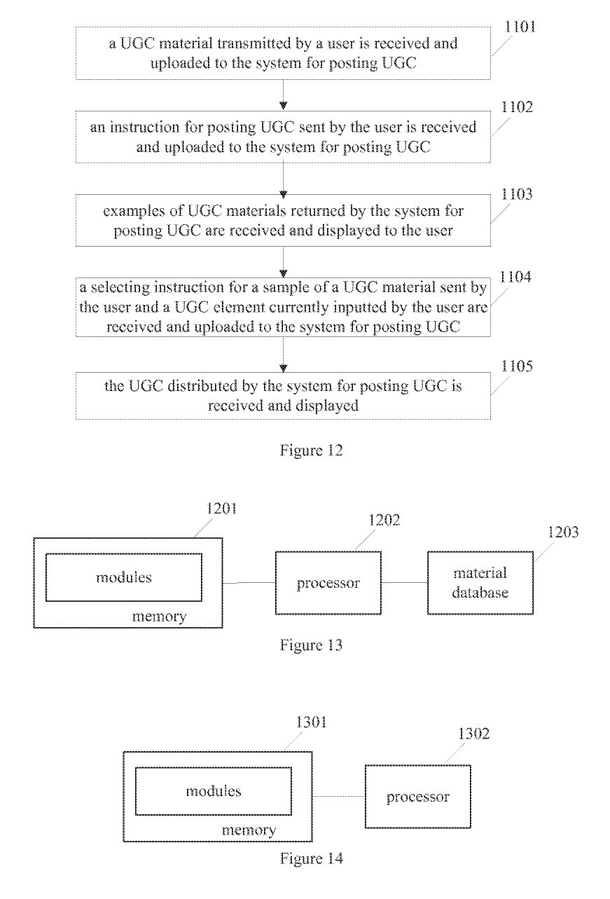

Corresponding to the front-end device, the present disclosure also provides a method for posing UGC by a front-end device, which may be executed by the front-end device. The front-end device may interact with a system for posting UGC in a UGC website system to complete the UGC attribution. FIG. 12 is a diagram illustrating a method for posing UGC by a front-end device according to various embodiments of the present disclosure. As shown in FIG. 12, the method may include the following operations.

Block 1101: A UGC material transmitted by a user is received and uploaded to the system for posting UGC.

Block 1102: An instruction for posting UGC sent by the user is received and uploaded to the system for posting UGC.

Block 1103: Examples of UGC materials returned by the system for posting UGC are received and displayed to the user.

Block 1104: A selecting instruction for a sample of a UGC material sent by the user and a UGC element currently input by the user are received and uploaded to the system for posting UGC.

Block 1105: The UGC distributed by the system for posting UGC is received and displayed.

According to various embodiments, the method may further include the following.

A material sharing instruction sent by an owner of a UGC material is received and uploaded to the system for posting UGC. The material sharing instruction includes an index of the UGC material to be shared and information of a sharer. The index of the UGC material to be shared is selected by the owner from indexes of UGC materials in an account of the owner.

When the sharer logs in to view an information packet including the index of the UGC material to be shared, information of the owner of the UGC material, information of a receiving instruction and a refusing instruction, and information of the information packet and the sample of the UGC material returned by the system for posting UGC are received and displayed. Instruction information for receiving or refusing the information packet triggered by the sharer is received and uploaded to the system for posting UGC.

According to various embodiments after the material sharing instruction is uploaded to the system for posting UGC, the method may further include the following. A material sharing withdrawal instruction sent by the owner of the UGC material is received and uploaded to the system for posting UGC. The material sharing withdrawal instruction includes an index of a shared UGC material which is withdrawn.

According to various embodiments, the method may further include the following. A deleting instruction for deleting a UGC material sent by the owner of the UGC material is received and uploaded to the system for posting UGC. The deleting instruction includes an identifier of an index of the UGC material to be deleted.

According to various embodiments, the UGC material transmitted by a user is received and uploaded to the system for posting UGC in block 1101 and may include the following. A request for transmitting a UGC material submitted by a user via a third-party website is received, a login state of the user in the UGC website system is verified by interacting with a UGC website system, a network address of the UGC material is extracted from the third-party website after the login state verification is passed, and the network address of the UGC material is uploaded to the system for posting UGC.

According to various embodiments, the UGC material transmitted by a user is received and uploaded to the system for posting UGC in block 1101 and may include the following. A request for transmitting a UGC material submitted by a user via a UGC website system is received, the user is prompted to input a network address of the UGC material to be transmitted or to directly upload the UGC material from the local, the network address of the UGC material input by the user is uploaded to the system for posting UGC, or the UGC material directly uploaded by the user from the local is uploaded to the system for posting UGC.

Various embodiments of the present disclosure may be achieved by executing a data handler by a data processing device, such as a computer. In addition, the data handler may be stored in a storage medium and may be executed by directly reading the data handler from the storage medium, or by installing or copying the data handler into a storage device (such as a hard disk and/or a memory) of a data processing device. The storage medium may be any recording means, such as paper storage medium (such as tape), magnetic storage medium (such as floppy disk, hard disk and flash memory), optical storage medium (such as CD-ROM), and magnetic and optical storage medium (such as MO). Optionally, it is possible to download the program codes from a server computer via a communication network.

The present disclosure also provides a storage medium on which the data handler is stored. The data handler implements any one of the method examples mentioned above.

The above mentioned examples may be implemented by hardware, software, firmware, or a combination thereof. For example, the various methods, processes, and functional modules described herein may be implemented by a processor (the term processor is to be interpreted broadly to include a CPU, processing unit/module, ASIC, logic module, or programmable gate array, etc.). The processes, methods, and functional modules may all be performed by a single processor or split between several processors. Reference in this disclosure or the claims to a ‘processor’ should thus be interpreted to mean ‘one or more processors’. The processes, methods, and functional modules are implemented as machine readable instructions executable by one or more processors, hardware logic circuitry of the one or more processors, or a combination thereof. The modules, if mentioned in the aforesaid examples, may be combined into one module or further divided into a plurality of sub-modules. Further, the examples disclosed herein may be implemented in the form of a software product, such as data handler. The computer software product may be stored in a storage medium and comprises a plurality of instructions for making an electronic device implement the method recited in various embodiments of the present disclosure.

FIG. 13 is a diagram illustrating another structure of the system for posting UGC according to various embodiments of the present disclosure. As shown in FIG. 13, the system for posting UGC may include a memory 1201, a processor 1202 in communication with the memory 1201, and a material database 1203 in communication with the processor 1202. The memory 1201 may store a group of instructions or modules which may be executed by the processor 1202 to implement the operations of modules and units of any one of the system for posting UGC shown in FIGS. 6 to 9.

FIG. 14 is a diagram illustrating another structure of the front-end device according to various embodiments of the present disclosure. As shown in FIG. 14, the front-end device may include a memory 1301 and a processor 1302 in communication with the memory 1301. The memory 1301 may store a group of instructions or modules which may be executed by the processor 1302 to implement the operations of modules and units of any one of the front-end devices shown in FIGS. 10 and 11.

The foregoing description, for purpose of explanation, has been described with reference to various embodiments. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrase “means for” or, in the case of a method claim, using the phrases “operation for” or “step for.”

What is claimed is:

1. A method for posting user generated content (UGC), comprising:
receiving a UGC material transmitted by a user, and storing the UGC material;
establishing an index of the UGC material and a sample of the UGC material, storing the sample of the UGC material and the index of the UGC material, and storing the index of the UGC material in an account of the user; and
after an instruction for posting UGC is received from the user, obtaining samples of UGC materials according to indexes of the UGC materials in the account of the user, and displaying the samples of the UGC materials for the user; receiving a sample of UGC material selected by the user and UGC elements currently inputted by the user;
reading a corresponding UGC material according to the sample of UGC material selected by the user; combining read UGC material and the UGC elements currently inputted by the user into UGC; and posting the UGC.

2. The method according to claim 1, further comprising:
receiving a material sharing instruction sent by an owner of a UGC material; the material sharing instruction comprises an index of a UGC material to be shared and information of a sharer; the index of the UGC material to be shared is selected by the owner from indexes of UGC materials in an account of the owner;
sending an information packet to the sharer; the information packet comprises an index of the UGC material to be shared, information of the owner of the UGC material, and information of a receiving instruction and a refusing instruction;
when the sharer logs in to view the information packet, obtaining a corresponding sample of the UGC material according to the index of the UGC material to be shared;
displaying obtained sample of the UGC material and the information of the owner of the UGC material to the sharer;
when the sharer triggers the information of the receiving instruction in the information packet, storing the index of the UGC material to be shared in the information packet into an account of the sharer.

3. The method according to claim 2, wherein after receiving the material sharing instruction sent by the owner of the UGC material, the method further comprises:
receiving a material sharing withdrawal instruction sent by the owner of the UGC material; the material sharing withdrawal instruction comprises an index of a shared UGC material to be withdrawn;
determining whether an index of the shared UGC material has been stored in the account of the sharer, when the index of the shared UGC material has not been stored in the account of the sharer, deleting the information packet to be sent to the sharer.

4. The method according to claim 2, further comprising:
receiving a deleting instruction sent by a user for deleting a UGC material stored in the account of the user; the deleting instruction comprises an identifier of an index of a UGC material to be deleted;
deleting the index of the UGC material designated by the identifier of the index of the UGC material to be deleted from the account of the user.

5. The method according to claim 4, further comprising:
recording information of the owner and sharers of the UGC material;
after the deleting instruction is received, the method further comprises: verifying whether the user is the owner of the UGC material to be deleted, when the user is the owner of the UGC material to be deleted, searching for information of sharers of the UGC material to be deleted, and deleting an index of the UGC material designated by the identifier of the index of UGC material to be deleted from accounts of the sharers.

6. The method according to claim 1, wherein the receiving the UGC material transmitted by a user comprises:
receiving a request for transmitting a UGC material submitted by a user via a third-party website;
verifying a login state of the user in a UGC website system;
after the login state verification is passed, extracting a network address of the UGC material to be transmitted from the third-party website;
obtaining the UGC material from the network address;
or, the receiving the UGC material transmitted by a user comprises:
receiving a request for transmitting a UGC material submitted by a user via a UGC website system;
prompting the user to input a network address of the UGC material to be transmitted or to directly upload the UGC material from the local;
receiving the network address of the UGC material inputted by the user, and obtaining the UGC material from the network address; or receiving the UGC material directly uploaded by the user from the local.

7. A system for posting user generated content (UGC), comprising: a memory and a processor in communication with the memory; wherein the memory comprises:
a receiving module, configured to receive a UGC material transmitted by a user, and store the UGC material;
an index module, configured to establish an index of the UGC material and a sample of the UGC material, store the sample of the UGC material and the index of the UGC material, and store the index of the UGC material in an account of the user; and
a posting module, which comprises:
a first posting unit, configured to, after receiving an instruction for posting UGC from a user, obtain samples of UGC materials according to indexes of the UGC materials in the account of the user, and display the samples for the user to select;
a second posting unit, configured to receive a sample selected by the user and UGC elements currently inputted by the user; and
a third posting unit, configured to read a corresponding UGC material according to the sample selected by the user, combine read UGC material and the UGC elements currently inputted by the user into UGC, and post the UGC.

8. The system according to claim 7, wherein the memory further comprises a sharing module, which comprises:
a first sharing unit, configured to receive a material sharing instruction sent by an owner of a UGC material; the material sharing instruction comprises an index of a UGC material to be shared and information of a sharer; the index of the UGC material to be shared is selected by the owner from indexes of UGC materials in an account of the owner;
a second sharing unit, configured to send an information packet to the sharer; the information packet comprises an index of the UGC material to be shared, information of the owner of the UGC material, and information of a receiving instruction and a refusing instruction;
a third sharing unit, configured to, when the sharer logs in to view the information packet, obtain a corresponding sample of the UGC material according to the index of the UGC material to be shared, and display obtained sample of the UGC material and the information of the owner of the UGC material to the sharer; and
a fourth sharing unit, configured to, when the sharer triggers the information of the receiving instruction in the information packet, store the index of the UGC material to be shared in the information packet into an account of the sharer.

9. The system according to claim 8, wherein the sharing module further comprises:
a fifth sharing unit, configured to receive a material sharing withdrawal instruction sent by the owner of the UGC material; the material sharing withdrawal instruction comprises an index of a shared UGC material to be withdrawn; and
a sixth sharing unit, configured to determine whether the index of the shared UGC material has been stored in the account of the sharer, when the index of the shared UGC material has not been stored in the account of the sharer, delete the information packet to be sent to the sharer.

10. The system according to claim 8, wherein the memory further comprises a deleting module, which comprises:
a first deleting unit, configured to receive a deleting instruction sent by a user for deleting a UGC material stored in the account of the user; the deleting instruction comprises an identifier of an index of a UGC material to be deleted; and
a second deleting unit, configured to, after the first deleting unit receives the deleting instruction, delete the index of the UGC material designated by the identifier of the index of the UGC material to be deleted from the account of the user.

11. The system according to claim 10, wherein the memory further comprises a permission module, configured to record information of the owner and sharers of the UGC material;
wherein the deleting module further comprises: a third deleting unit, configured to, after the first deleting unit receives the deleting instruction, verify whether the user is the owner of the UGC material to be deleted, when the user is the owner of the UGC material to be deleted, search for information of sharers of the UGC material to be deleted, and delete an index of the UGC material designated by the identifier of the index of UGC material to be deleted from accounts of the sharers.

12. The system according to claim 7, wherein the receiving module comprises:
a third-party receiving unit, configured to receive a request for transmitting a UGC material submitted by a user via a third-party website;
a verifying unit, configured to verify a login state of the user in a UGC website system;
a third-party address obtaining unit, configured to, after the login state verification is passed, extract a network address of the UGC material to be transmitted from the third-party website; and
a first material obtaining unit, configured to obtain the UGC material from the network address;
or, the receiving module comprises:
a local receiving unit, configured to receive a request for transmitting a UGC material submitted by a user via a UGC website system;
a prompt unit, configured to prompt the user to input a network address of the UGC material to be transmitted or to directly upload the UGC material from the local; and
a second material obtaining unit, configured to receive the network address of the UGC material inputted by the user, and obtain the UGC material from the network address; or receive the UGC material directly uploaded by the user from the local;
calculating an actual hash value of compressed page content of the page to be browsed by the user; and
comparing he real hash value of compressed page content of the page to be browsed by the user with the actual hash value of compressed page content of the page to be browsed by the user.

13. A front-end device for posting user generated content (UGC), comprising: a memory and a processor in communication with the memory; wherein the memory comprises:
a terminal receiving module, configured to receive a UGC material transmitted by a user, and upload the UGC material to a system for posting UGC; and
a terminal posting module, which comprises:
a first terminal posting unit, configured to receive an instruction for posting UGC from a user, and upload the instruction for posting UGC to the system for posting UGC;
a second terminal posting unit, configured to receive samples of UGC materials returned by the system for posting UGC, and display the samples of UGC materials to the user;
a third terminal posting unit, configured to receive a selecting instruction of a sample of a UGC material from the user and a UGC element currently inputted by the user, upload the selecting instruction of the sample of the UGC material and a UGC element currently inputted by the user to the system for posting UGC; and
a fourth terminal posting unit, configured to receive UGC distributed by the system for posting UGC, and display the UGC.

14. The front-end device according to claim 13, wherein the memory further comprises a terminal sharing module, which comprises:
a first terminal sharing unit, configured to receive a material sharing instruction sent by an owner of a UGC material, and upload the material sharing instruction to the system for posting UGC; the material sharing instruction comprises an index of a UGC material to be shared and information of a sharer; the index of the UGC material to be shared is selected by the owner from indexes of UGC materials in an account of the owner;
a second terminal sharing unit, configured to, when the sharer logs in to view an information packet comprising the index of the UGC material to be shared, information of the owner of the UGC material, and information of a receiving instruction and a refusing instruction, receive information of the information packet and a sample of the UGC material returned by the system for posting UGC, and display the sample of the UGC material and information of the information packet to the sharer; and
a third terminal sharing unit, configured to receive instruction information for receiving or refusing the information packet triggered by the sharer, and upload the instruction information to the system for posting UGC.

15. The front-end device according to claim 14, wherein the memory further comprises a terminal deleting module, configured to receive a deleting instruction for deleting a UGC material sent by the owner of the UGC material, and upload the deleting instruction to the system for posting UGC; the deleting instruction comprises an identifier of an index of the UGC material to be deleted.

16. The front-end device according to claim 13, wherein the terminal receiving module comprises:
a third-party receiving unit, configured to receive a request for transmitting a UGC material submitted by a user via a third-party website;
a verifying unit, configured to interact with a UGC website system, and verify a login state of the user in the UGC website system; and
a third-party address obtaining unit, configured to, after the login state verification is passed, extract a network address of the UGC material to be transmitted from the third-party website, and upload the network address to the system for posting UGC;
or, the terminal receiving module comprises:
a local receiving unit, configured to receive a request for transmitting a UGC material submitted by a user via a UGC website system;
a prompt unit, configured to prompt the user to input a network address of the UGC material to be transmitted or to directly upload the UGC material from the local; and
a transmitting unit, configured to upload the network address of the UGC material inputted by the user to the system for posting UGC, or upload the UGC material directly uploaded by the user from the local to the system for posting UGC.

17. A method for posting user generated content (UGC) by a front-end device, comprising:
receiving a UGC material transmitted by a user, and uploading the UGC material to a system for posting UGC;
receiving an instruction for posting UGC from a user, and uploading the instruction for posting UGC to the system for posting UGC;
receiving samples of UGC materials returned by the system for posting UGC, and displaying the samples of UGC materials to the user;
receiving a selecting instruction of a sample of a UGC material from the user and a UGC element currently inputted by the user, and uploading the selecting instruction of the sample of the UGC material and a UGC element currently inputted by the user to the system for posting UGC; and
receiving UGC distributed by the system for posting UGC, and displaying the UGC.

18. The method according to claim 17, further comprising:
receiving a material sharing instruction sent by an owner of a UGC material, and uploading the material sharing instruction to the system for posting UGC; the material sharing instruction comprises an index of a UGC material to be shared and information of a sharer; the index of the UGC material to be shared is selected by the owner from indexes of UGC materials in an account of the owner;
when the sharer logs in to view an information packet comprising the index of the UGC material to be shared, information of the owner of the UGC material, and information of a receiving instruction and a refusing instruction, receiving information of the information packet and a sample of the UGC material returned by the system for posting UGC, and displaying the sample of the UGC material and information of the information packet to the sharer; and
receiving instruction information for receiving or refusing the information packet triggered by the sharer, and uploading the instruction information to the system for posting UGC.

19. The method according to claim 18, further comprising:
receiving a deleting instruction for deleting a UGC material sent by the owner of the UGC material, and uploading the deleting instruction to the system for posting UGC; the deleting instruction comprises an identifier of an index of the UGC material to be deleted.

20. The method according to claim 17, wherein receiving the UGC material transmitted by the user, and uploading the UGC material to the system for posting UGC comprises:
receiving a request for transmitting a UGC material submitted by a user via a third-party website;
interacting with a UGC website system, and verifying a login state of the user in the UGC website system;
after the login state verification is passed, extracting a network address of the UGC material to be transmitted from the third-party website, and uploading the network address to the system for posting UGC;
or, the receiving the UGC material transmitted by the user, and uploading the UGC material to the system for posting UGC comprises:
receiving a request for transmitting a UGC material submitted by a user via a UGC website system;
prompting the user to input a network address of the UGC material to be transmitted or to directly upload the UGC material from the local; and
uploading the network address of the UGC material inputted by the user to the system for posting UGC, or uploading the UGC material directly uploaded by the user from the local to the system for posting UGC.
